(19) United States
(12) Patent Application Publication
(10) Pub. No.: US 2011/0290512 A1
(43) Pub. Date: Dec. 1, 2011

(54) PRECISION GARDEN HOE

(76) Inventor: Mark Cook, Dinuba, CA (US)

(21) Appl. No.: 13/114,680

(22) Filed: May 24, 2011

Related U.S. Application Data
(60) Provisional application No. 61/347,931, filed on May 25, 2010.

(51) Int. Cl. A01B 1/08; A01B 1/06; B23P 15/00

(52) U.S. Cl. 172/371; 76/109

(57) ABSTRACT

A precision garden hoe includes a blade having a curved upper edge, a curved lower edge, pointed tips at the sides where the edges meet, and front and rear surfaces; a handle adapted to be held by a user; and a shaft having a front end attached to the rear surface of the blade, a rear end attached to the handle, and a bend so that the blade is at a non-perpendicular angle relative to the handle. The edges of the blade may be sharp. The bend in the shaft may be at an angle so that, when attached at a perpendicular angle to the front end of the shaft, the blade will be at a non-perpendicular angle relative to the rear end of the shaft.

### RELATED APPLICATIONS

This application claims the benefit of the filing date of U.S. Patent Application No. 61/347,931, filed May 25, 2010, which is incorporated herein by reference in its entirety.

### BACKGROUND OF THE INVENTION

The present invention generally relates to gardening tools and more specifically to a precision garden hoe.

Currently existing weeding devices, further referred to as hoes, are large and bulky. Many times during use they destroy plants that are desirable or beneficial. The blades of existing hoes are generally perpendicular to the straight shaft.

It would be desirable to have a hoe that can allow for precise eradication of unwanted plants.

### SUMMARY OF THE INVENTION

In one aspect of the present invention, a device includes a blade having a curved upper edge, a curved lower edge, pointed tips at the sides where the edges meet, and front and rear surfaces; a handle adapted to be held by a user; and a shaft having a front end attached to the rear surface of the blade, a rear end attached to the handle, and a bend so that the blade is at a non-perpendicular angle relative to the handle.

In another aspect of the present invention, a garden hoe includes a blade having a center section that tapers to each opposing side, the upper and lower curves providing a double curved body; an elongated shaft having a bent section towards a first end, the first end attached to the blade; and a handle attached at a second end of the elongated shaft.

In yet another aspect of the present invention, a method of making a garden hoe includes stamping a blade from plate steel, the blade having upper and lower edges; sharpening the lower edge of the blade; exerting pressure from a die to the blade so as to create a convex-curved blade; exerting pressure on a straight shaft to create a bent shaft; flatting a front end of the bent shaft and welding the first end to the blade; and pressing a handle onto a rear end of the shaft, thereby making a garden hoe.

### BRIEF DESCRIPTION OF THE DRAWINGS

FIG. 1 shows a perspective view of a hoe according to an exemplary embodiment of the invention;

FIG. 2 shows a top view of the hoe shown in FIG. 1;

FIG. 3 shows an end view of the hoe shown in FIG. 1;

FIG. 4 shows a side view of the hoe shown in FIG. 1; and

FIG. 5 shows a section view of the hoe taken along the line 30 in FIG. 2.

### DETAILED DESCRIPTION

The preferred embodiment and other embodiments, which can be used in industry and include the best mode now known of carrying out the invention, are hereby described in detail with reference to the drawings. Further embodiments, features and advantages will become apparent from the ensuing description, or may be learned without undue experimentation. The figures are not necessarily drawn to scale, except where otherwise indicated. The following description of embodiments, even if phrased in terms of “the invention” or what the embodiment “is,” is not to be taken in a limiting sense, but describes the manner and process of making and using the invention. The coverage of this patent will be described in the claims. The order in which steps are listed in the claims does not necessarily indicate that the steps must be performed in that order.

Broadly, an embodiment of the present invention generally provides a garden hoe for performing precision work. The hoe of the present invention may include a small, precision blade with double curvature that may allow for precise eradication of unwanted plants.

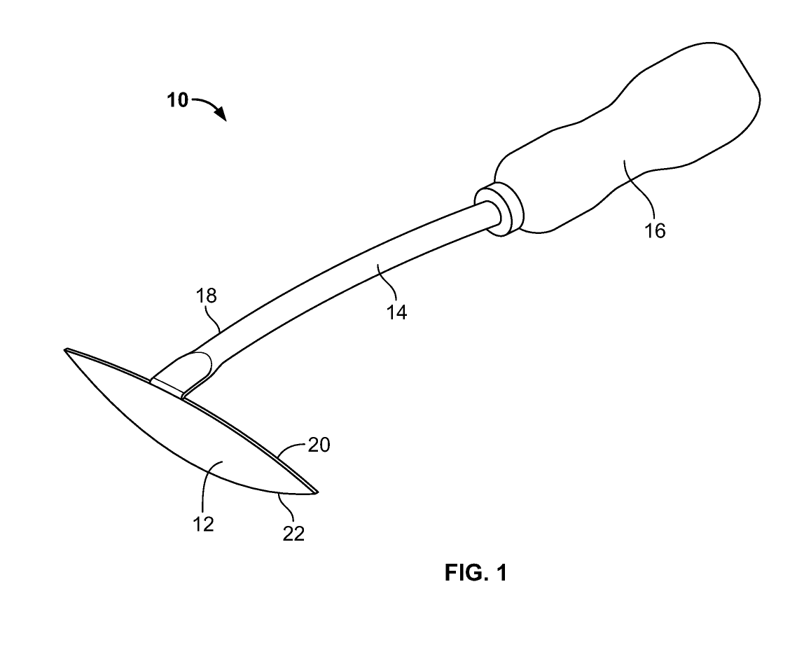

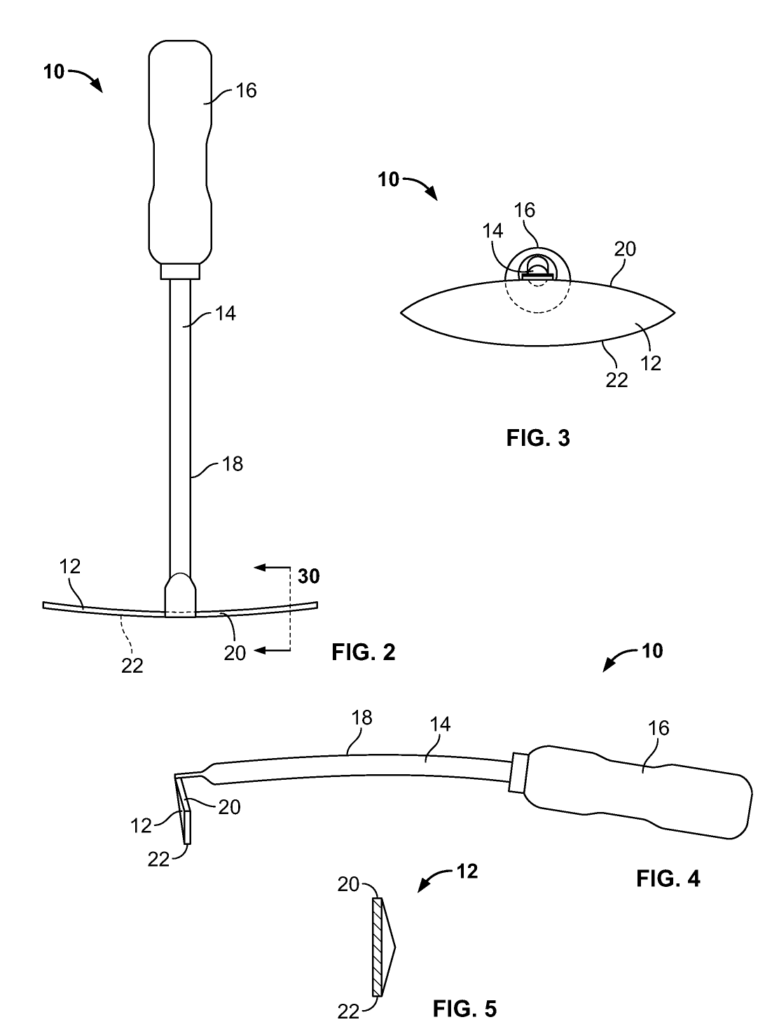

As depicted in FIGS. 1-4, an exemplary embodiment of a precision garden hoe 10 may include a blade 12, attached to a shaft 14, which is attached to a handle 16. As depicted in FIGS. 1 and 4, the shaft may have a bend 18 near the front end. As depicted in FIGS. 2 and 5, the blade may have a slight convex curve.

The blade 12 may have rigid construction, such as a steel construction, and may be shaped like a marquis diamond. The blade 12 may be wide in the middle and tapering to points at each end, and curved along its length and width. The blade 12 may be sharpened on one or both long edges, thereby providing an upper blade edge 20 and a lower blade edge 22. The shaft 14 may have about a 0.375+/−0.060 inch diameter and may be made from steel or other suitable rigid material with a 12-20 degree angle providing a bend 18 that changes the angle of the blade 12 relative to the shaft 14 and handle 16, which can promote ease and precision of use. For example, the angle of the blade relative to the ground may change from the usual 90 degrees relative to the shaft to approximately 120 degrees relative to the shaft. The handle 16 may be, for example, a Douglas fir or hardwood handle for a user's comfort.

Embodiments of a blade 12 may have a length of between 4 and 6 inches long, and may have a width of between 1 and 1.125 inches at its center, which may taper to a point at each end, along an upper blade edge 20 and a lower blade edge 22. The back side of the blade 12 may be approximately 0.100+/−0.060 inch thick, and may taper to a sharpened edge along its face. The blade 12 may be curved along its length by between 5 to 7 degrees, and may also have a slight curve along its width by approximately 2 degrees. This may cause the outer surface of the blade to be convex relative to the shaft, e.g. having a slight curve toward the shaft so that the blade bulges forward. This configuration may give a double curved shape to the blade. The material may be mild steel that has been heat treated but may also be high carbon steel.

An embodiment of a shaft 14 may be made of 0.375 inch diameter steel +/−0.060 for strength and weight distribution. The shaft 14 may be from 8 inches long to 10 inches long depending on model. At approximately 2.5 inches from the end, such as from 1.5 to 4 inches, the shaft 14 may have a bend 18 at an angle of between 12-20 degrees. This bend 18 may serve to put the blade 12 at an angle with the soil. The tip of the shaft 14 on the bent end may be flattened to facilitate welding to the blade 12.

Embodiments of a handle may be a common Douglas fir handle or hardwood of a suitable overall length, e.g., about 6 inches. The diameter of the handle may vary, but the nominal diameter may be 1.125 inches. In another embodiment, the handle may be extended to 5 feet in length to facilitate use from a standing position. Such a handle may be a common Douglas fir or hardwood wooden handle of approximately 1.125 inches in diameter. Embodiments of a blade may be attached to the shaft via electrical welding, forming a very strong connection. The shaft, with its tip flattened, may create a wider anchor point for the welding process. The shaft may be attached to the blade along the back side, which may be flat and at the blades thickest portion for the ultimate in strength. The bend in the handle may face forward, placing the blade in better contact with the soil substrate. The shaft may then be joined with the handle via press fit in a cavity, but may also be attached with some form of adhesive.

The double curvature of the blade along with its pointed tips may allow for precise control when working in tight spaces. Embodiments may allow eradication of undesirable plant material while leaving desirable plants untouched. The curved shaft may function to put the blade at the correct angle to facilitate fine shaving-type eradication of plant matter as opposed to the current digging, which is prevalent with flat components. The pointed tips of the blade may also allow for digging if the operator so chooses, but may also be used for precise control in confined areas. The pointed tips may also work well for making furrows needed for planting small seeds at close intervals. The handle may provide a comfortable grip, which allows extended use without discomfort.

To make an embodiment of the present invention, the blade may be stamped from mild plate steel and then sharpened along one long edge. The blade may then be placed in a forming die and pressure may be exerted to push the blade into the die, creating the double curve, and the blade may receive a mild heat treatment for strengthening and to hold its edge better. The shaft may be cut to length by automated machines and placed into a jig. Pressure may be applied to push the steel into the jig, creating the bend. At this point the shaft may be heated at the tip and may be struck by a press to flatten the tip for welding to the blade. The blade and shaft may then be joined by mechanical welding either by hand or automated welder. These components may then be cleansed, deburred, and sent off for powder coating to create a durable finish. Finally the blade-shaft combination may be pressed into the wooden handle giving the finished product.

To use an embodiment of the present invention, an operator may use the hoe by holding the handle and dragging the hoe lightly along the soil slicing off unwanted plant material. The operator may also turn the tool on its side and use the sharp pointed tips to create furrows for planting or for aggressive digging at heavy root material.

An embodiment of a garden hoe may include a blade having a center section that tapers to each opposing side, the blade configured into a double curved body; an elongated curved shaft having a bent section towards a first end which attaches to the blade; and a handle attached at a second end of the elongated shaft.

I claim:

1. A device comprising:
a blade having a curved upper edge, a curved lower edge, pointed tips at the sides where the edges meet, and front and rear surfaces;
a handle adapted to be held by a user; and
a shaft having a front end attached to the rear surface of the blade, a rear end attached to the handle, and a bend so that the blade is at a non-perpendicular angle relative to the handle.

2. The device of claim 1, wherein the bend in the shaft is from 12 to 20 degrees so that the blade, when attached at a perpendicular angle to the front end of the shaft, will be at a non-perpendicular angle relative to the rear end of the shaft.

3. The device of claim 1, wherein the shaft is generally straight in front of the bend and behind the bend so that the bend forms an angle in the shaft.

4. The device of claim 1, wherein the lower edge of the blade is sharp so as to facilitate use as a garden hoe.

5. The device of claim 1, wherein the shaft is from 0.315 to 0.435 inches in diameter, the blade is from 4 and 6 inches between point tips and from 0.07 to 0.13 inches in thickness; and the distance between pointed tips is between 1 and 1.125 inches.

6. The device of claim 1, wherein the blade has a slight curve so that the front surface of the blade is convex relative to the shaft.

7. The device of claim 1, wherein the shaft is from 8 to 10 inches long and the bend located from 1.5 to 4 inches from the front end of the shaft.

8. The device of claim 1, wherein the front end of the shaft is flattened to provide an area larger than the diameter of the shaft to attach the shaft to the blade.

9. A garden hoe comprising:
a blade having a center section that tapers to each opposing side, the upper and lower curves providing a double curved body;
an elongated shaft having a bent section towards a first end, the first end attached to the blade; and
a handle attached at a second end of the elongated shaft.

10. A method of making a garden hoe, the method comprising:
stamping a blade from plate steel, the blade having upper and lower edges;
sharpening the lower edge of the blade;
exerting pressure from a die to the blade so as to create a convex-curved blade;
exerting pressure on a straight shaft to create a bent shaft;
flatting a front end of the bent shaft and welding the first end to the blade; and
pressing a handle onto a rear end of the shaft, thereby making a garden hoe.

11. The method of claim 10, wherein the bend in the shaft is from 12 to 20 degrees so that the blade, when attached at a perpendicular angle to the front end of the shaft, will be at a non-perpendicular angle relative to the rear end of the shaft.
